(19) United States
(12) Patent Application Publication
(10) Pub. No.: US 2015/0001924 A1
(43) Pub. Date: Jan. 1, 2015

(54) LATCHING RELAY DRIVE CIRCUIT WITH INTERLOCKING WITH THE IGNITION SWITCH OF A VEHICLE

(71) Applicant: YAZAKI CORPORATION, Minato-ku, Tokyo (JP)

(72) Inventor: Yukio Kamiya, Shizuoka (JP)

(73) Assignee: YAZAKI CORPORATION, Minato-ku, Tokyo (JP)

(21) Appl. No.: 14/368,028

(22) PCT Filed: Nov. 26, 2012
(86) PCT No.: PCT/JP2012/007557

§ 371 Date: Jun. 23, 2014

(30) Foreign Application Priority Data
Dec. 26, 2011 (JP) 2011-283303

(51) Int. Cl. H01H 47/22

(52) U.S. Cl. CPC H01H 47/22; H01H 2300/024
USPC 307/9.1

(57) ABSTRACT

When a trouble is caused to a control signal output function of a controller (9), each of output ports of control signals of the controller (9) is brought into a high impedance state. Turning on or off an ignition switch (IGN) in this state generates an alternative bias signal in a switch signal input circuit (11) or an inverter (13). The generated alternative bias signal is applied to a set coil energizing switch (7a) or a reset coil energizing switch (7b). Thus, a latching relay (5) can be driven on and off, interlocking with an on-operation or an off-operation of the ignition switch (IGN).

### TECHNICAL FIELD

The present invention relates to a latching relay drive circuit used for a vehicle.

### BACKGROUND ART

A latching relay for latching an on/off state of a switch is used for a vehicle as well, for example, for turning on and off a travel system load, a light system load, and the like. For turning on and off the latching relay, it is necessary to energize coils corresponding to on and off operations, respectively, by using an on-control signal and an off-control signal. In the vehicle, control signals from ECU (Electronic Control Unit or Engine Control Unit) are exclusively used for turning on and off the latching relay.

Thus, when any trouble associated with control signal output is caused to the controller such as ECU, thereby disabling to properly turn on the latching relay used for the travel system load, light system load, and the like of the vehicle, a trouble may be also caused not only to safety travel of the vehicle but also to the vehicle's self-travel to a repair shop. Then, a group of the applicant (Yazaki Corporation) et al. proposed in the past a circuit capable of turning on the latching relay once an ignition switch is turned on, even if a trouble is caused to the control signal output of the controller (refer PTL 1).

Further, a proposal was also made in the past that, when the supply voltage to the controller drops, a discharge voltage of a capacitor charged before the voltage drop is applied to a reset coil of the latching relay to thereby latch the latching relay to an off-state (refer PTL 2).

### CITATION LIST

### Patent Literature

[PTL 1]

JP 2003-019932 A

[PTL 2]

JP 2001-332161 A

### SUMMARY OF INVENTION

The conventional technology disclosed in PTL 1 focuses on reliably turning on the latching relay when a trouble is caused to the control signal output of the controller. On the other hand, for example, when the trouble is caused to the control signal output of the controller when the latching relay is in the on-state, it is conceivable that a non-used load is left connected to a battery and held as it is, to thereby cause a useless consumption of the battery. However, the conventional technology disclosed in PTL 1 fails to propose a structure for turning off the latching relay.

On the other hand, the conventional technology disclosed in PTL 2 focuses on latching the latching relay to the off-state irrespective of the control signal outputted by the controller. However, the latching relay is latched to the off-state only when the supply voltage to the controller drops. This fails to make a proper operation in such an occasion as that latching the latching relay to the off-state at an arbitrary timing is desired so as to prevent the above useless consumption of the battery.

The present invention has been made in view of the above circumstances. It is an object of the present invention to provide a latching relay drive circuit used for a vehicle which, even when a trouble is caused to a control signal output of a controller, enables to arbitrarily turn on and off the latching relay used for turning on and off a load of a vehicle according to usage condition and the like of the load .

For accomplishing the above object, there is provided a latching relay drive circuit used for a vehicle according to a first aspect of the present invention, wherein the drive circuit is interposed between a battery of a vehicle and a load of the vehicle and configured to make an on/off drive of a latching relay latched to an on-state and an off-state, respectively, by biasing and turning on a set coil energizing switch and a reset coil energizing switch by a set control signal or a reset control signal which are outputted from a controller, the drive circuit including: a set coil bias circuit configured to generate, from a switch signal observed when an ignition switch of the vehicle is in an on-state, a first alternative bias signal replacing the set control signal and to bias the set coil energizing switch by the first alternative bias signal; and a reset coil bias circuit configured to generate, from the switch signal observed when the ignition switch is in an off-state, a second alternative bias signal replacing the reset control signal, the second alternative bias signal having a reversed signal level of the first alternative bias signal replacing the set control signal, and to bias the reset coil energizing switch by the second alternative bias signal.

With the above structure, it is when the ignition switch is in the on-state that the latching relay is latched to the on-state to thereby connect the battery of the vehicle with the load of the vehicle. This brings about a switch state suitable for a situation for actuating the load by supplying the power from the battery. On the other hand, when the ignition switch is to be brought into an off-state, it is conceivable that the operating of the load is not expected.

Thus, even when the trouble is caused to the control signal output of the controller of the vehicle, the latching relay can be arbitrarily turned on or off according to the usage condition and the like of the load of the vehicle by turning on or off the ignition switch .

The latching relay drive circuit according to the first aspect of the present invention may further include: a delay circuit configured to delay, for a predetermined period longer than or equal to an initialization period of the controller, the biasing of the set coil energizing switch by the first alternative bias signal.

With the above structure, even when the first alternative bias signal is generated by the set coil bias circuit, the set coil energizing switch is not immediately turned on, but is turned on by being biased after being delayed for a predetermined time. This predetermined time is set to longer than or equal to the initialization period of the controller.

Herein, it is assumed that a disconnected battery is connected in the on-state of the ignition switch. The controller which was not supplied with the power while the battery was disconnected does not start immediately upon connection of the battery to the controller but will start after a lapse of the initialization period (for example, 60 msec). Thus, the controller's control signal output port to each of the energizing circuits of the set coil and reset coil of the latching relay is brought into the high impedance state (like one observed in the non-supply of the power) until the initialization period elapses.

When the control signal output port is in the high impedance state, even if the trouble is not caused to the control signal output function of the controller, the first alternative bias signal of the set coil bias circuit or the second alternative bias signal of the reset coil bias circuit renders a state to enable to bias and turn on the set coil energizing switch or the reset coil energizing switch.

Thus, for example, in the case of a vehicle using the latching relay for a starter relay of a manual transmission (MT) vehicle and when the control signal output port is in the high impedance state, erroneously connecting the battery with the latching relay with the ignition switch turned on will instantly turn on the latching relay by the first alternative bias signal of the set coil bias circuit. Then, it is likely to cause such an unexpected accident as the starter motor is actuated immediately after the connecting of the battery to thereby move the vehicle.

Contrary to the above, delaying, for the predetermined time, the biasing of the set coil energizing switch by the first alternative bias signal of the set coil bias circuit can allow the on/off drive of the latching relay by the first alternative bias signal only when the trouble is caused to the control signal output with the controller in the start state.

With the latching relay drive circuit according to the first aspect of the present invention, even when the trouble is caused to the control signal output of the controller, the latching relay used for turning on and off the load of the vehicle can be arbitrarily turned on or off according to the usage condition and the like of the load.

### BRIEF DESCRIPTION OF DRAWINGS

[FIG. 1]

FIG. 1 is a circuit diagram illustrating a fundamental structure of a latching relay drive circuit used for a vehicle according to an embodiment.

[FIG. 2]

FIG. 2 is a flowchart illustrating operational procedures of the latching relay drive circuit illustrated in FIG. 1.

[FIG. 3]

FIG. 3 is a circuit diagram illustrating a fundamental structure of the latching relay drive circuit according to another embodiment.

### DESCRIPTION OF EMBODIMENTS

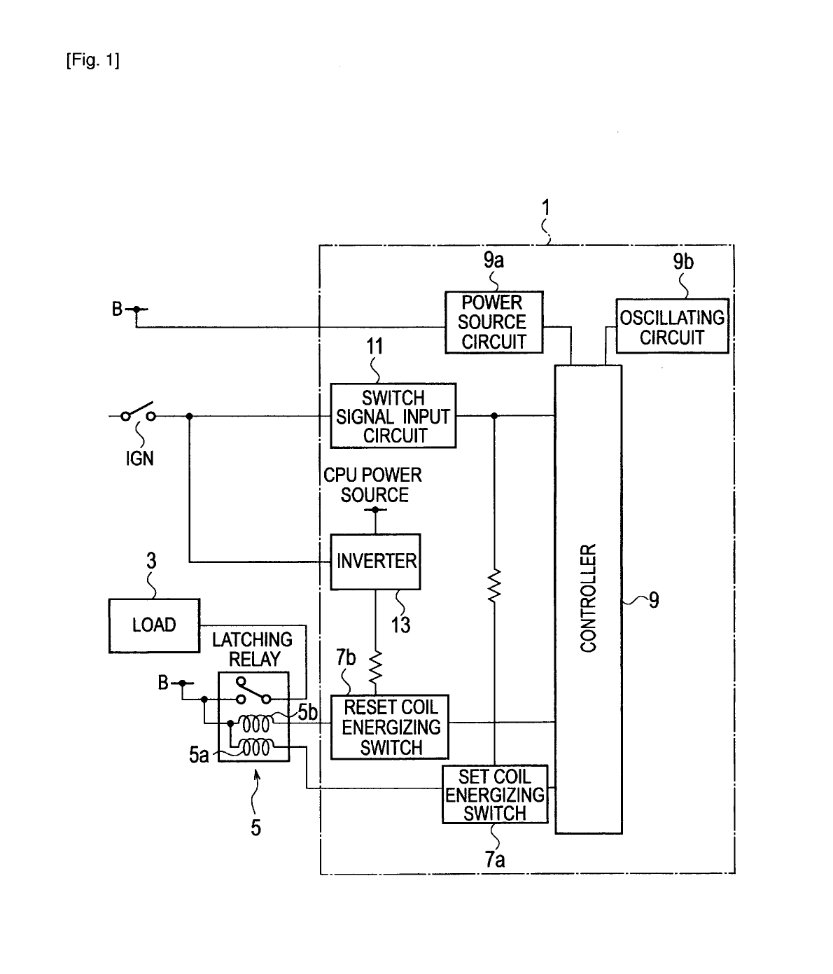

Hereinafter, embodiments of the present invention will be explained with reference to FIGS. 1 to 3.

A latching relay drive circuit (hereinafter referred to as “drive circuit”) 1 for a vehicle according to an embodiment is used for driving a latching relay 5 which turns on and off supplying a power from a vehicular battery B to a load 3 such as one for travel system and light system.

The drive circuit 1 includes a set coil energizing switch 7a for turning on and off energization of a set coil 5a of the latching relay 5, a reset coil energizing switch 7b for turning on and off energization of a reset coil 5b of the latching relay 5, and a controller 9 for making an on/off control of the set coil energizing switch 7a and the reset coil energizing switch 7b.

Each of the energizing switches 7a, 7b includes a switching transistor where a collector and an emitter are communicated with each other by biasing a base potential. The controller 9 has output ports of control signals for biasing the base potential of each of the energizing switches 7a, 7b. The controller 9 is operated by a power from the battery B with the power dropped to a proper voltage (for example, 5V) by a power source circuit 9a, and implements various processes at a period synchronous with a clock from an oscillator 9b.

The controller 9 may include, for example, an ECU. According to the drive control signal of the load 3 inputted responding to the state of each portion of the vehicle, the controller 9 controls supplying the power from the battery B to the load 3 by making on/off operations of the latching relay 5 (bias of base potential of each of the energizing switches 7a, 7b).

Further, each of the output ports of the control signals of the controller 9 for biasing the base potential of each of the energizing switches 7a, 7b is brought into a high impedance state when a trouble is caused to the operation of the controller 9. Further, each of the output ports of the control signals is brought into the high impedance state as well during a predetermined period (=initialization period) from when the controller 9 starts receiving the power from the power source circuit 9a to when the controller 9 starts operation.

Further, the drive circuit 1 includes a switch signal input circuit 11 (set coil bias circuit) and an inverter 13 (reset coil bias circuit) into each of which a switch signal at a signal level responding to an on/off state of a vehicular ignition switch IGN is inputted.

The switch signal input circuit 11 is connected to the base of the set coil energizing switch 7a. When the switch signal is at the signal level responding to the on-state of the ignition switch IGN, the switch signal input circuit 11 outputs a first alternative bias signal for biasing the base potential of the set coil energizing switch 7a. When the switch signal is at the signal level responding to the off-state of the ignition switch IGN, the switch signal input circuit 11 stops outputting the first alternative bias signal.

The inverter 13 is connected to the base of the reset coil energizing switch 7b. When the switch signal is at the signal level responding to the off-state of the ignition switch IGN, the inverter 13 outputs a second alternative bias signal for biasing the base potential of the reset coil energizing switch 7b. When the switch signal is at the signal level responding to the on-state of the ignition switch IGN, the inverter 13 stops outputting the second alternative bias signal.

In addition, although not illustrated in FIG. 1, a diode and the like for preventing a reverse current are provided in proper portions of the drive circuit 1.

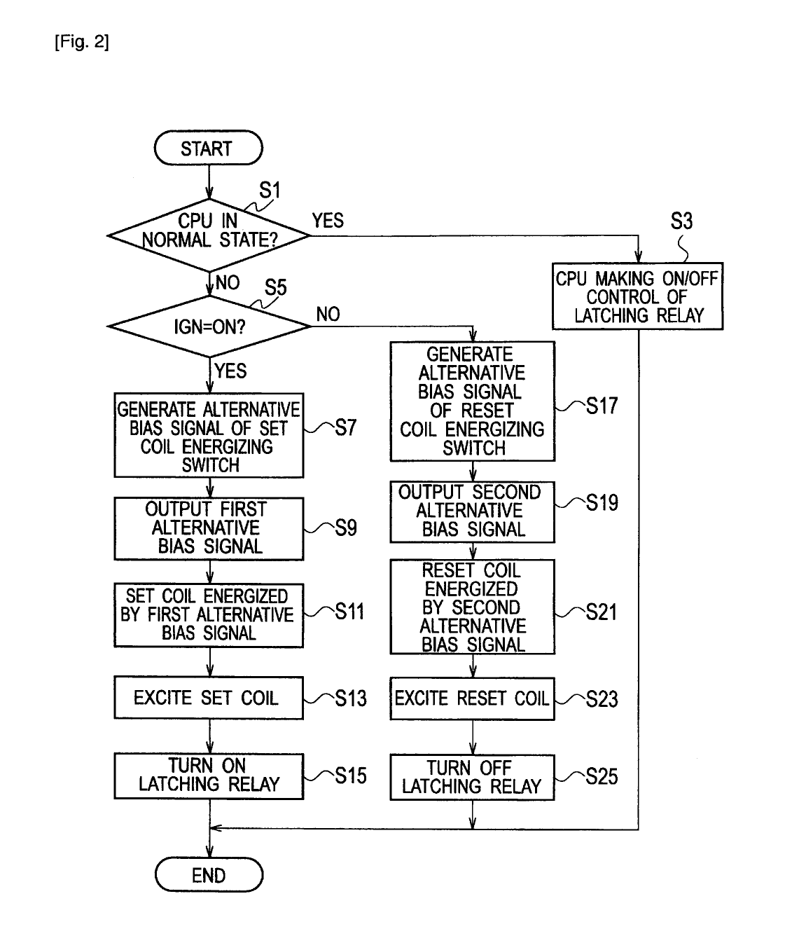

Next, an explanation about procedures of the operation of the drive circuit 1 having the above structure will be made with reference to a flowchart of FIG. 2.

First, when the controller 9 (CPU) is in conformity (YES at S1), the controller 9 makes the on/off control of the latching relay 5 (RLY) by the control signals outputted by the controller 9 to the base of each of the energizing switches 7a, 7b (S3).

On the other hand, when the controller 9 is not in conformity (NO at S1), it is verified whether or not the ignition switch IGN is turned on (S5). When the ignition switch IGN is turned on (YES at S5), the switch signal input circuit 11 generates the first alternative bias signal (S7) to thereby output the first alternative bias signal to the set coil energizing switch 7a (S9).

Next, the set coil 5a of the latching relay 5 is energized through the set coil energizing switch 7a turned on by the first alternative bias signal from the switch signal input circuit 11 (S11), to thereby excite the set coil 5a (S13). Then, the excited set coil 5a turns on the latching relay 5 (S15).

Contrary to the above, when the ignition switch IGN is not turned on (NO at S5), the inverter 13 generates the second alternative bias signal (S17) to thereby output the second alternative bias signal to the reset coil energizing switch 7b (S19).

Next, the reset coil 5b of the latching relay 5 is energized through the reset coil energizing switch 7b turned on by the second alternative bias signal from the inverter 13 (S21), to thereby excite the reset coil 5b (S23). Then, the excited reset coil 5b turns off the latching relay 5 (S25).

With the drive circuit 1 of the embodiment having the above structure, when the trouble is caused to the control signal output function of the controller 9 to the set coil energizing switch 7a or the reset coil energizing switch 7b, each of the output ports of the control signals is brought into the high impedance state. Turning on and off the ignition switch IGN in this state generates the first alternative bias signal in the switch signal input circuit 11 or the second alternative bias signal in the inverter 13. The generated alternative bias signal is applied to the base of the switching transistor included in the set coil energizing switch 7a or the reset coil energizing switch 7b since each of the output ports of the control signals of the controller 9 is in the high impedance state. Thus, being interlocked with the on/off operation of the ignition switch IGN, the latching relay 5 can be driven on and off.

In this way, when the control signal output function of the controller 9 has the trouble, the drive circuit 1 according to the embodiment turns on and off the latching relay 5 by the on/off operation of the ignition switch IGN, thus enabling to switch the on-operation and off-operation of supplying the power to the load 3 at an arbitrary timing responding to the necessity or needlessness of usage and the like.

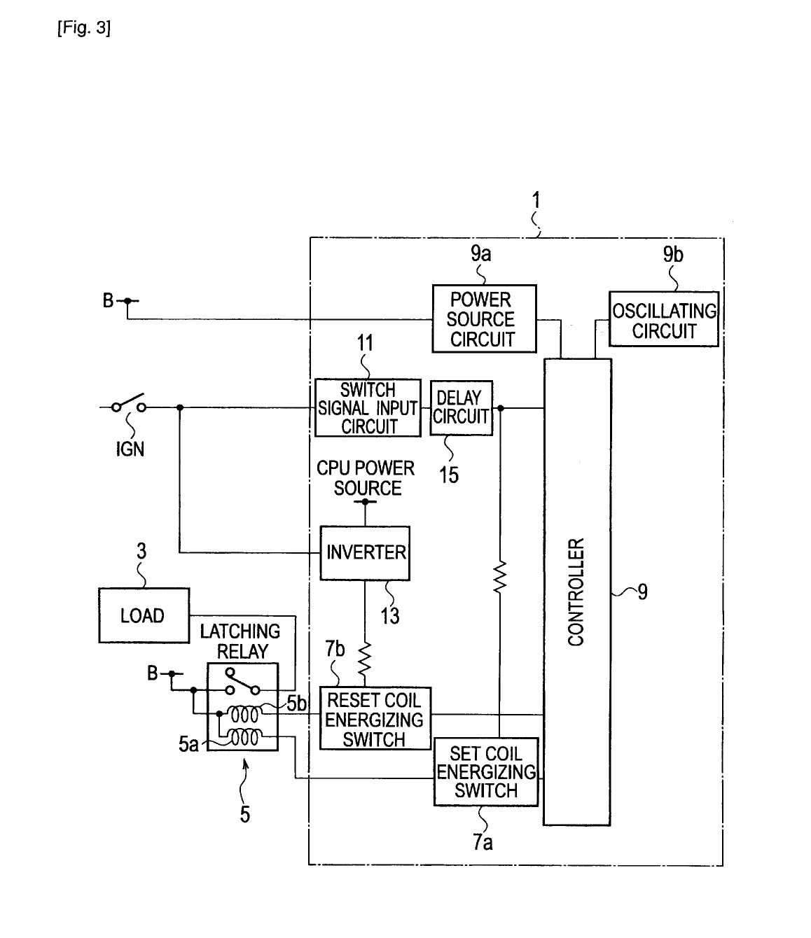

Further, as illustrated in the circuit diagram in FIG. 3, a delay circuit 15 may be added to a latter step (viewed from the ignition switch IGN) of the switch signal input circuit 11. The delay circuit 15 may be a general RC circuit having a time constant defined by a conventionally known resistor R and capacitor C. Further, the time constant of the delay circuit 15 is set to a value that is proper for defining a delay time by the delay circuit 15 to a time longer than or equal to the initialization period from when the controller 9 starts receiving the power from the power source circuit 9a to when the controller 9 starts operation.

The structure further provided with the delay circuit 15 is effective, especially, in the case where the initialization period of the controller 9 is too long to ignore. If the initialization period of the controller 9 is long, in the case of a restart of supplying the power to the controller 9 from the power source circuit 9a which has been suspended due to, for example, replacement of the battery B and the like, each of the output ports of the control signals is brought into the high impedance state during a period until the initialization period elapses, even though no trouble is caused to the function of the control signal output. If the ignition switch IGN is turned on during the above period, the latching relay 5 is turned on by the first alternative bias signal generated by the switch signal input circuit 11, to thereby turn on supplying the power from the battery B to the load 3.

For example, where the latching relay 5 is used as a starter relay of a vehicle, replacing the battery B with the ignition switch IGN kept turned on makes the latching relay 5 turn on immediately after the connection of the battery B, thus operating a starter motor to thereby move the vehicle.

However, when the delay circuit 15 delays, for longer than or equal to the initialization period, the applying of the first alternative bias signal from the switch signal input circuit 11 to the base of the set coil energizing switch 7a, a state to enable the controller 9 to start and make the on/off control of the latching relay 5 by the control signal is rendered before the bias of the energizing switch 7a by the first alternative bias signal. This can prevent occurrence of such an unexpected situation as that the starter motor is operated immediately after the above replacing of the battery B ; and only when the trouble is caused to the control signal output function of the controller 9, the on/off drive of the latching relay 5 can be implemented by the alternative bias signal.

### INDUSTRIAL APPLICABILITY

The present invention is extremely useful when used for a latching relay drive circuit used for a vehicle.

1. A drive circuit interposed between a battery of a vehicle and a load of the vehicle and configured to make an on/off drive of a latching relay latched to an on-state and an off-state, respectively, by biasing and turning on a set coil energizing switch and a reset coil energizing switch by a set control signal or a reset control signal which are outputted from a controller, the drive circuit comprising:
a set coil bias circuit configured to generate, from a switch signal observed when an ignition switch of the vehicle is in an on-state, a first alternative bias signal replacing the set control signal and to bias the set coil energizing switch by the first alternative bias signal; and
a reset coil bias circuit configured to generate, from the switch signal observed when the ignition switch is in an off-state, a second alternative bias signal replacing the reset control signal, the second alternative bias signal having an inverted signal level of the first alternative bias signal replacing the set control signal, and to bias the reset coil energizing switch by the second alternative bias signal.

2. The drive circuit according to claim 1, further comprising:
a delay circuit configured to delay, for a predetermined period longer than or equal to an initialization period of the controller, the biasing of the set coil energizing switch by the first alternative bias signal.
